(19) United States
(12) Patent Application Publication
(10) Pub. No.: US 2007/0197289 A1
(43) Pub. Date: Aug. 23, 2007

(54) GAMING MACHINE

(75) Inventors: Jun FUJIMOTO, Koto-ku (JP); Masatsugu Kobayashi, Koto-ku (JP); Keika Yokoyama, Koto-ku (JP); Hiroshi Ohno, Koto-ku (JP); Tomoaki Oomori, Koto-ku (JP); Mayumi Takeda, Koto-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corp., Koto-ku (JP)

(21) Appl. No.: 11/676,909

(22) Filed: Feb. 20, 2007

(30) Foreign Application Priority Data
Feb. 21, 2006 (JP) 2006-043857

(51) Int. Cl. A63F 13/00

(52) U.S. Cl. 463/32

(57) ABSTRACT

The present invention provides a gaming machine which allows players to observe a gaming image which is displayed for one player without being influenced by a gaming image which is displayed for another player in perfoming a game in which a plurality of players can play, and to reduce an equipment cost and an installation space. A display device 2 which adopts dual view liquid crystal is mounted on an approximately center of the gaming machine 1, and a common screen showing a common gaming situation to both players is displayed for the first and the second players P1, P2 and, at the same time, corresponding to the gaming situation, a first image which shows a gaming situation on the first player P1 is displayed for the first player within an angle range of θ2 and, simultaneously, a second image which shows a gaming situation on the second player P2 is displayed for the second player within an angle range of θ2.

### RELATED APPLICATION

This application claims the priority of Japanese Patent Application No. 2006-043857 filed on Feb. 21, 2006, which is incorporated herein by reference.

### BACKGROUND OF THE INVENTION

1. Field of the Invention

The present invention relates to a gaming machine which uses a display device capable of displaying images which differ from each other corresponding to a viewing angle.

2. Description of the Related Art

Recently, as a display device which is mounted on one liquid crystal display, a display device which uses dual view liquid crystal capable of displaying images which differ from each other corresponding to a viewing angle, and a display device which uses veil view liquid crystal capable of electrically changing a viewing angle have been commercialized. The dual view liquid crystal is capable of simultaneously displaying respectively independent information in two different directions by providing a parallax-optical element such as a parallax barrier or a lenticular lens array on a general TFT liquid crystal panel. For example, the dual view liquid crystal can display different images when the liquid crystal panel is viewed from left side thereof and right side thereof respectively. Further, the display device which uses the veil view liquid crystal is constituted by combining a panel which changes transmissivity of light and is referred to as a switch panel and a liquid crystal panel which displays images. Advancing of light in the lateral direction is controlled by applying a voltage to the switch panel so as to lower the transmissivity of light and hence, a viewer can observe a display content from a front side of the liquid crystal panel but cannot observe the display content from the left and right directions of the liquid crystal panel.

Further, as an image display device which further develops or improves the above-mentioned image display device adopting the dual view liquid crystal, patent document 1 (JP-A-2005-78094) discloses, for example, an image display device which can set an angular range that a viewer can observe an image in one direction narrower than an angular range that a viewer can observe an image in another direction. Due to such a constitution, when the image display device is mounted on an automobile, for example, it is possible to provide a display of an image of car navigation only to a driver and a display of an image of a TV program or a movie only to fellow passengers on a front passenger seat and a rear seat.

Patent document 2 (JP-A-2005-78092) discloses an image display device in which a divergent lens array in a form of a plane-convex lens, for example, is provided in front of a parallax optical element so as to increase an angular separation between an image displayed on one side and an image displayed on another side and, at the same time, a liquid crystal layer or the like, for example, is provided between the parallax optical element and the divergent lens array so as to control a reflective index of the liquid crystal layer thus easily controlling and selecting the angular separation between above-mentioned two images.

Patent document 3 (JP-A-2005-78091) discloses an image display device in which an image can be displayed with a high contrast ratio when the image displayed on one side and the image displayed on another side are observed in the different directions, respectively. That is, patent document 3 discloses the image display device in which the image which the viewer can observe in one direction is darkly observed when the viewer observes in another direction and the image which the viewer can observe in another direction is darkly observed when the viewer observes in one direction.

Patent document 4 (JP-A-2005-78080) discloses an image display device in which a lenticular lens array, for example, is provided between an image display element such as liquid crystal and a parallax optical element arranged behind the image display element, wherein by suitably selecting a focal length of the lenticular lens array, the angular separation between the image displayed in one direction and the image displayed in another direction can be enlarged or reduced.

Patent document 5 (JP-A-2005-78078) discloses a display device adopting a dual view liquid crystal which includes a display in which a plurality of units each of which is defined by three pixels of red, green and blue is arranged and a parallax barrier which is constituted by alternately arranging an opaque region and a slit, wherein a plurality of color filters which allow light of one color or two colors to pass light of one color or two colors out of red, green and blue to pass through a slit portion of the parallax barrier is suitably combined and arranged so as to provide an image display device which can suppress the lowering of brightness and the generation of crosstalk.

Patent document 6 (JP-A-2005-78076) discloses, for example, an image display device in which an extremely thin resin layer or a glass layer which has optical transmittance is formed by deposition between a liquid crystal layer of a liquid crystal display and a parallax barrier, wherein by making a distance between a pixel surface of the liquid crystal display and the parallax barrier small, the angular separation between an image which a viewer can observe in one direction and an image which the viewer can observe in another direction is increased.

Here, conventionally, in a match game in which a plurality of players can take part, respective monitors are mounted on gaming machines which respective players play, and these gaming machines are connected to each other via communication lines so as to allow monitors of respective gaming machines to display images corresponding to respective players. Further, as another method, for example, in a match game which simulates a sport such as tennis, a single gaming machine which includes a plurality of controllers and one monitor displays one common image to a plurality of players on the monitor.

In the former case, for example, when a player plays the match game with a friend of the player, there is no other choice but the players have to play sitting side by side, or when a next seat is occupied, the players have to play at seats distant from each other. In some cases, the players are compelled to play the match game at positions where the players cannot observe their faces each other. In view of such circumstances, there has been proposed a gaming machine for a match game which mounts cameras thereon so as to allow the players to see their faces. In this case, a camera becomes necessary for each player thus giving rise to a drawback that a manufacturing cost is pushed up.

Further, in the latter case, for example, when players play a so-called fighting game or role playing game, it is difficult to display a gaming image with highly vivid presence as observed from respective players sides and the gaming machine is limited to a game of a category in which both players fight each other can share the same gaming image. Accordingly, the utilization of a game housing which allows the replacement of software of the gaming machine is limited thus limiting the use of the software of the gaming machine. Further, assume that a display region of the monitor is divided and images corresponding to respective players are displayed on the divided display regions, there arises a drawback that a size of the game image for one player becomes small and, at the same time, an image for another player enters one player's eye and hence, it is difficult for one player to play the game.

### SUMMARY OF THE INVENTION

Accordingly, it is an object of the present invention to provide a gaming machine which, in performing a game which allows a plurality of players to attend, allows one player to observe a gaming image which is displayed for one player without being influenced by a gaming image which is displayed for another player, and can reduce an installation cost and an installation space.

To achieve the above-mentioned object, the present invention is characterized in that a gaming machine including a first input unit to which instructions from a first player are inputted, a second input unit to which instructions from a second player are inputted, a storing unit which stores a program for executing a game which is played by the first and the second player, a game control unit which controls the game by reading the program from the storing unit and by performing processing in response to the instructions which are inputted into the first and the second input unit in accordance with the programs, wherein the gaming machine includes a display device which has a screen which displays images indicative of a situation of the game controlled by the game control unit and is capable of displaying a first image which is visible from a first direction and is not visible from a second direction which differs from the first direction and a second image which is visible from the second direction and is not visible from the first direction on the screen and, a display control unit which performs a control to allow the display device to display the situation of the game relevant to the first player as the first image and the situation of the game relevant to the second player as the second image.

Further, in the above-mentioned gaming machine, the present invention is characterized in that the game which is executed by the programs is a game which advances in a gaming space due to behavior of a first object which is manipulated by a first player and a second object which is manipulated by a second player, the game control unit prepares the gaming space, controls the respective behaviors of the first and the second objects in the gaming space based on the instructions inputted from the first and the second input units and, at the same time, determines a relative distance in the gaming space between the first and the second objects by figuring out the respective positions of the first and the second objects in the gaming space, and the display control unit in response to the relative distance between the first and the second objects in the gaming space which is determined by the game control unit changes over the screen between a common screen which indicates the behavior of the first and the second objects in the gaming space and individual screens which indicate an image as viewed from the first object in the gaming space as the first image and an image as viewed from the second object in the gaming space as the second image.

### BRIEF EXPLANATION OF DRAWINGS

FIG. 1A and FIG. 1B are views showing an appearance of a gaming machine of the embodiment of the present invention, wherein FIG. 1A is a front view and FIG. 1B is a plan view;

FIG. 2 is an explanatory view showing the principle of dual view liquid crystal adopted by the display device of the gaming machine;

FIG. 3 is a block diagram showing the hardware constitution which performs a game control of the gaming machine;

FIG. 4 is an explanatory view showing the constitution of pixels in the display device of the gaming machine;

FIG. 5 is a flowchart showing a flow of main processing of a simulation game performed by the gaming machine;

FIG. 6 is a flowchart showing a flow of game processing of the simulation game performed in the gaming machine;

FIG. 7 is an explanatory view showing a content of a common screen of the simulation game performed in the gaming machine;

FIG. 8A and FIG. 8B are explanatory views for explaining a moving method of a unit in the simulation game performed in the gaming machine;

FIG. 9 is a flow chart showing a flow of moving processing of the simulation game performed in the gaming machine;

FIG. 10 is a flow chart showing a flow of attack processing of the simulation game performed in the gaming machine;

FIG. 11 is an explanatory view showing an attack method by a unit in the simulation game performed in the gaming machine;

FIG. 12A and FIG. 12B are explanatory views showing contents of individual screens of the simulation game performed in the gaming machine;

FIG. 13 is an explanatory view showing a display method of a common screen of the simulation game performed in the gaming machine;

FIG. 14A, FIG. 14B and FIG. 14C are explanatory view for explaining a display method of individual screens of the simulation game performed in the gaming machine; and

FIG. 15 is an explanatory view for explaining a content of a performance indicating screen of the simulation game performed in the gaming machine.

### DESCRIPTION OF THE PREFERRED EMBODIMENTS

Hereinafter, preferred embodiments of the present invention are explained by taking a gaming machine which is installed in a so-called game arcade as an example in conjunction with the drawings. The gaming machine of the embodiment includes a display device and provides a simulation game in which, in a map displayed on the display device, two players alternately manipulate a plurality of pieces (hereinafter, referred to as units) such as soldiers and tanks which are respectively allocated to two players and either one of players wins the game by totally destroying the units of the opponent or occupying a station of the opponent.

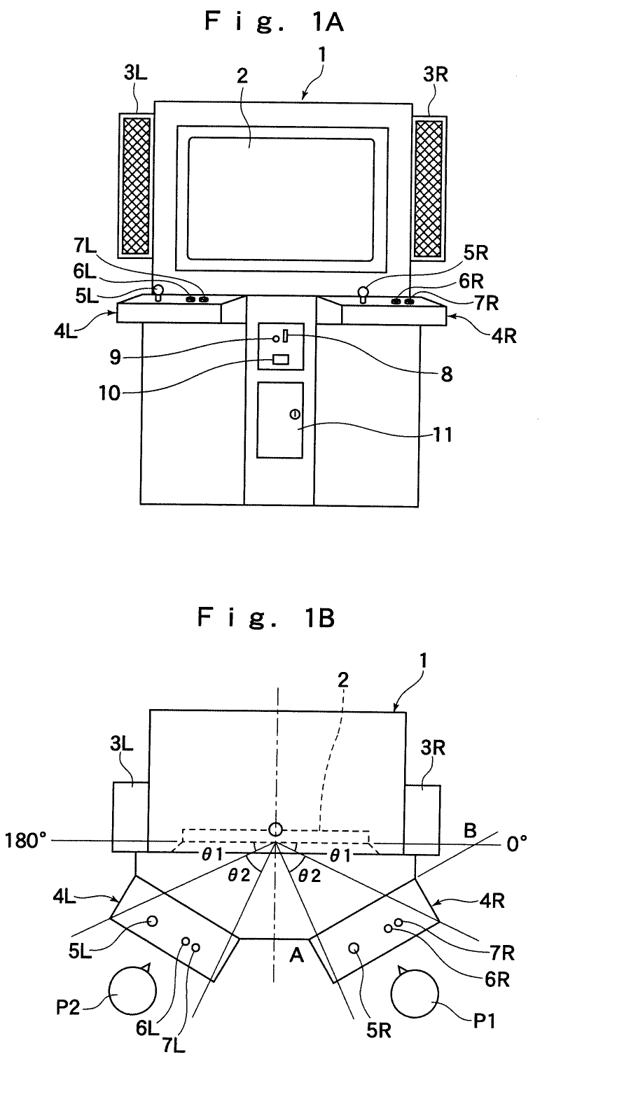

FIG. 1A and FIG. 1B are views showing an appearance of a gaming machine of the embodiment, wherein FIG. 1A is a front view of the gaming machine and FIG. 1B is a plan view of the gaming machine. In the gaming machine 1 shown in these drawings, a display device 2 for displaying a gaming situation to the player using an image is mounted on a front upper portion of the gaming machine 1. The display device is a liquid crystal image display device having the resolution of 640×480 dots which includes so-called dual view liquid crystal. The display device is capable of not only providing a display of an image of the same content to a first player P1 and a second player P2 respectively but also providing a display of an image as viewed from the first direction and an image as viewed from the second direction which differ from each other on the screen of the display device 2. Here, an angle of the first direction is not fixed and, as shown in FIG. 1B, the angle of the first direction ranges from an angle θ1 to an angle θ1+θ2 as measured from the center of the screen of the display device 2 as an origin. In the same manner, an angle of the second direction ranges from 180 degrees −θ1 to 180 degrees −(θ1+θ2). Here, the above-mentioned angles θ1 and θ2 are determined corresponding to the structure of the display device 2.

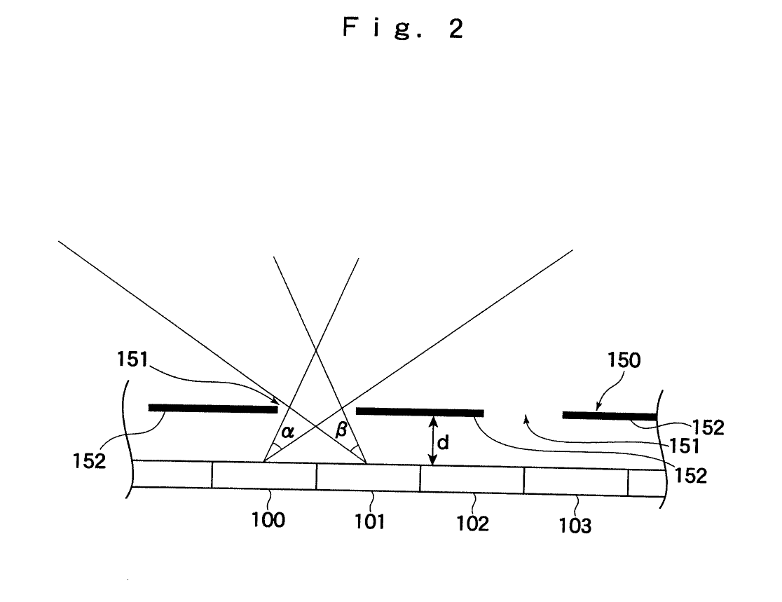

The principle which enables the screen of the dual view liquid crystal to display different images corresponding to the viewing directions is simply explained in conjunction with FIG. 2. FIG. 2 is a plan view showing the cross-sectional structure of a portion of dual view liquid crystal schematically. In the drawing, an upper side is an image display screen (hereinafter, referred to as a front screen) which provides a display of an image to the player. The screen of dual view liquid crystal is formed of liquid crystal cells which are arranged in a matrix array of 640 rows and 480 columns. Liquid crystal cells 100 to 103 in FIG. 2 are some of liquid crystal cells arranged in the row direction (the lateral direction of the screen). Further, on a back surface side of liquid crystal cells 100 to 103, that is, on a lower side in FIG. 2, a light source (for example, a cold cathode tube) not shown in the drawing is mounted and the light source illuminates the liquid crystal cells 100 to 103 from the back surface. On the other hand, on a front side, that is, on an upper side in FIG. 2 of the liquid crystal cells, a parallax barrier 150 is mounted. The parallax barrier 150 is configured such that light transmitting slits 151 which allow the light to pass therethrough and opaque regions 152 which prevent the light from passing therethrough are alternately arranged in the columnar direction and are arranged with a gap of a length d from surfaces of the liquid crystal cells 100 to 103. Further, slits formed in the light transmitting slit 151 are formed over the whole region in the row direction (the longitudinal direction of the screen).

In the dual view liquid crystal which has the above-mentioned structure, when the player views the screen from the direction within a range of an angle α, the player can observe light which passes through the liquid crystal cell 100 but cannot observe light which passes through the liquid crystal cell 101. To the contrary, when the player views the screen from the direction within a range of an angle β, the player can observe light which passes through the liquid crystal cell 101 but cannot observe light which passes through the liquid crystal cell 101. In this manner, by making the image which is displayed using the liquid crystal cells 100, 102 and the image which is displayed using the liquid crystal cells 101, 103 different from each other, it is possible to display different images respectively between the case in which the player sees the dual view liquid crystal from the direction within a range of the angle a and the case in which the player sees the dual view liquid crystal from the direction within a range of the angle β. Here, the degrees of the angle α, β are determined based on lengths in the columnar direction or the relative positional relationship of the liquid cells and the light transmitting slits in the row direction, the gap between the liquid crystal cells and the parallax barrier or the like.

A right speaker 3R is mounted on a right side and a left speaker 3L is mounted on a left side of the display device 2 respectively. The right speaker 3R and the left speaker 3L output sound effects and background music (hereinafter, referred to as BGM) which are generated during the game. On the lower side of the display device 2 and in front of the gaming machine 1, a first control part 4R which is manipulated by the first player P1 and a second control part 4L which is manipulated by the second player P2 are mounted. Shapes of upper surfaces of these first and second control parts 4R, 4L are formed into a substantially rectangular shape as shown in FIG. 1B. The first control panel 4R and the second control panel 4L are not arranged in parallel to the screen of the display device 2 but are mounted on the gaming machine 1 at an angle which makes the first control panel 4R and the second control panel 4L arranged slightly inwardly. In the embodiment, to take the first control panel 4R as an example, an angle ∠ABO (an angle in which the first control panel 4R is arranged inwardly) which is made between a long side of the first control panel 4R and the display device 2 is set to a value which falls within a range from the angle θ1 to angle θ1+θ2.

Further, on upper surfaces of the first and second control panels 4R, 4L, an input unit which allows the respective first and second players to input instructions to the gaming machine 1 are mounted. Since the constitution of the input unit is in common between the first and second control panels 4R, 4L, hereinafter, for the sake of brevity of the explanation, the explanation is made with respect to the constitution of the input unit of the first control panel 4R. On a left side of the first control panel 4R, a joystick 5R which is capable of instructing four directions of right-and-left directions and up-and-down directions is mounted, and the first player P1 performs various kinds of selections during a time that the player P1 plays the game by manipulating the joy stick 5R. Further, on a right side of the first control panel 4R, a decision button 6R and a cancel button 7R each of which is a push-button switch are mounted. The decision button 6R is a button which determines the selection performed using the joy stick 5R, while the cancel button 7R is a button which cancels contents which are once selected using the joy stick 5R.

These joy stick 5R, the decision button 6R and the cancel button 7R are, as shown in FIG. 1B, arranged on a straight line in parallel with the long sides of the upper surface of the first control panel 4R. Further, each of the joy stick 5R, the decision button 6R and the cancel button 7R is arranged within an angle region (a range from θ1 to θ1+θ2) of the first direction. In this manner, when the first player P1 plays the game, a body of the player is naturally positioned within the angle region of the first direction. Further, as mentioned above, by setting the angle ∠ABO which is made between the long side of the first control panel 4R and the display device 2 to a value which falls within a range from the angle θ1 to angle θ1+θ2, when the first player P1 faces the first control panel 4R directly, the player's eyes naturally see the screen of the display device 2 from the first direction. Here, on the upper surface of the second control panel 4L, the joy stick 5L, the decision button 6L and the cancel button 7L are arranged in the same manner as the joy stick 5R, the decision button 6R and the cancel button 7R. However, since the explanation of the joy stick 5L, the decision button 6L and the cancel button 7L is overlapped, the explanation is omitted.

Next, in FIG. 1A, on the upper portion of a vertical surface which is positioned between the first control panel 4R and the second control panel 4L, a coin insertion slot 8 for inserting a coin when the player plays a game with the gaming machine 1 is mounted. On a left side of the coin insertion slot 8, a return button 9 for allowing the coin to return when the inserted coin is clogged in the inside of the gaming machine 1 is mounted. Further, on a lower side of the coin insertion slot 8 and the return button 9, a return port 10 for taking out the coin which returns by pushing the return button 9 is mounted. On a lower side of the return port 10, a collecting door 11 which is opened and closed when the coins inserted into the gaming machine 1 are collected is mounted.

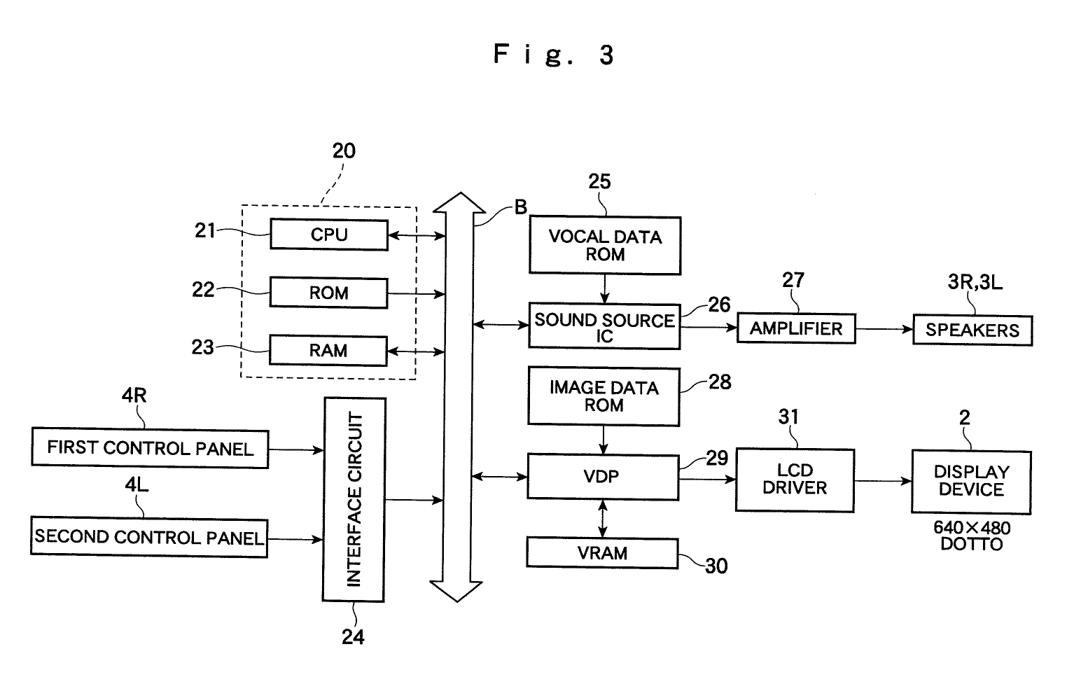

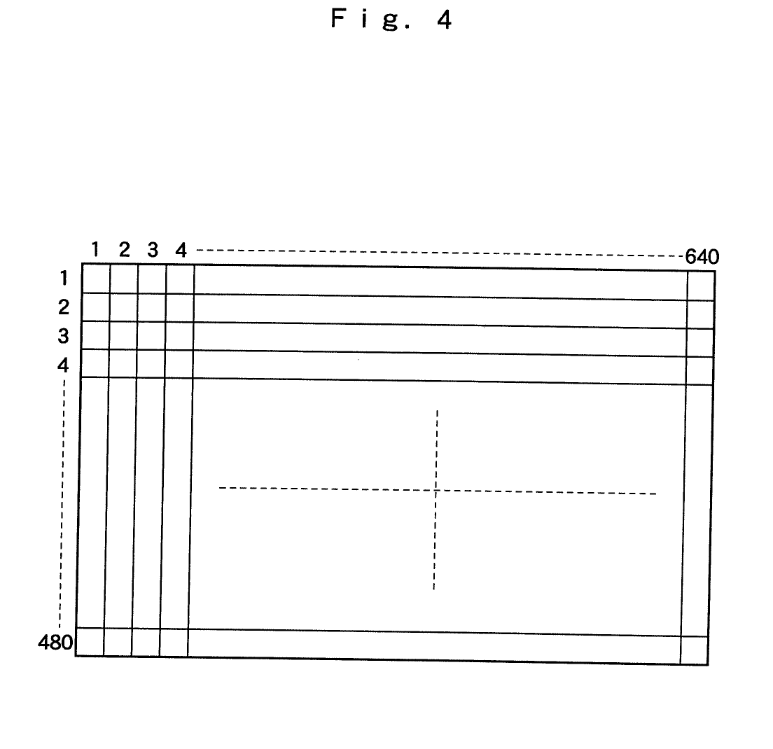

Next, the main hardware structure which is relevant to a control of the game performed on the gaming machine 1 is explained in conjunction with a block diagram shown in FIG. 3. In FIG. 3, a control unit 20 is a unit which controls a simulation game performed on the gaming machine 1, and the control unit 20 includes a CPU 21, a ROM 22 and a RAM 23. The CPU 21 executes a simulation game program which is stored in the ROM 22, advances the simulation game in response to the instruction which is inputted from the first and second control panel 4R and 4L by the respective players, and controls the generation of sound effects and the BGM and an image to be displayed on the display device 2 corresponding to the progress of the game. The ROM 22 stores, together with the above-mentioned simulation game program, various kinds of data such as data which shows performance of various kinds of units which are used in the simulation game, data on a size of a map which is indicative of a gaming space of the simulation game of this embodiment or topography of the map (hereinafter, referred to as map data), and arrangement data of various kinds of units (described later) in the map at a time of starting the game. That is, the ROM 22 corresponds to a storing unit which stores the programs for executing the game.

In the RAM 23, various kinds of information which are changed along with the execution of the simulation game are stored. As one example of the information, in addition to information showing positions of respective units in the map, the number of turn and the number of units which are allocated to the respective players, various kinds of flags such as a phase flag P which indicates which of the first player P1 or the second player P2 is a turn to attack and finish flags END1, END2 which indicate which one of the first player P1 or the second player P2 satisfies a finish condition are stored. The contents of the information are explained later. Further, the CPU 21 gets access to the ROM 22 and the RAM 23 via a bus B. Still further, the transmission and the reception of the data are performed between the CPU 21 and various kinds of devices described later via the bus B.

An interface circuit 24 receives information relevant to the manipulating directions of the joy sticks 5R, 5L which are respectively outputted from the first and second control panels 4R, 4L and ON/OFF signals of the decision buttons 6R, 6L and the cancel buttons 7R, 7L and, thereafter, the interface circuit 24 outputs the information and the signals to the CPU 21 via the bus B. In a vocal data ROM 25, sound effects which are generated during the game and musical sound/musical sound data of BGM are stored. A sound source IC 26 reads the musical sound/musical sound data from the vocal data ROM 25 in accordance with the instruction which is outputted from the CPU 21 via the bus B. Then, the sound source IC 26 changes the data into analog signals and, thereafter, outputs the data to an amplifier 27. The amplifier 27 amplifies the analog signals which are outputted from the sound source IC 26 and, thereafter, outputs the signals to the speakers 3L, 3R. In this manner, sound effects and the BGM which are instructed by the CPU 21 are outputted from the speakers 3L, 3R.

In an image data ROM 28, various kinds of image data which is displayed on the display device 2 such as image data which shows various kinds of units, image data for displaying the map and motion picture data for displaying a combat scene are stored. A image data processor (hereinafter, referred to as a VDP) 29 reads the image data from the image data ROM 28 in response to the instruction outputted from the CPU 21 via the bus B. Then, the VDP 29 forms the image data which is displayed on the display device 2 by writing the image data into a VRAM 30 and, thereafter, outputs the formed image data to an LCD driver 31. The LCD driver 31 drives respective liquid crystal cells which constitutes the screen of the display device 2 at a predetermined timing based on the image data outputted from the VDP 29. Here, as described above, the screen of the display device 2 is, as shown in FIG. 4, formed of pixels which are arranged in a matrix array of 640 rows and 480 columns. Accordingly, the VRAM 30 possesses addresses corresponding to respective pixels which are specified by the respective 1 to 640th rows and the respective 1 to 480th columns shown in FIG. 4, wherein in each address, gray-scale (or color) information on the corresponding pixel is stored. Here, in this embodiment, it is assumed that the first player P1 sees an image displayed on pixel arrays of odd numbers while the second player P2 views an image displayed on pixel arrays of even numbers.

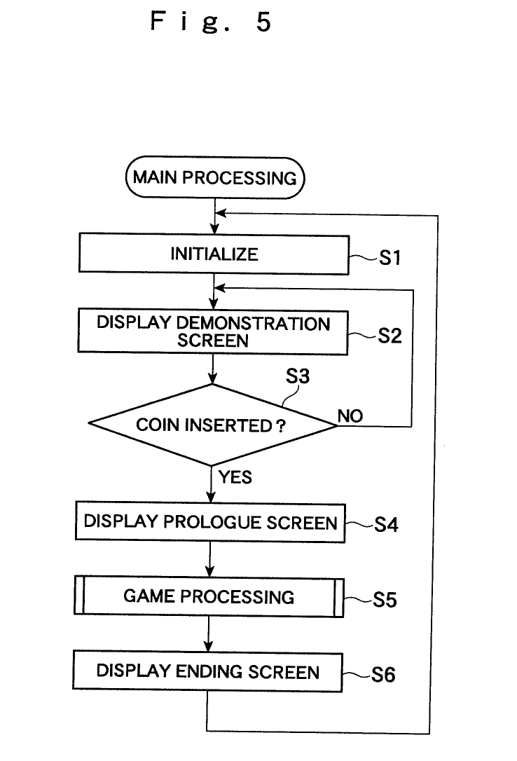

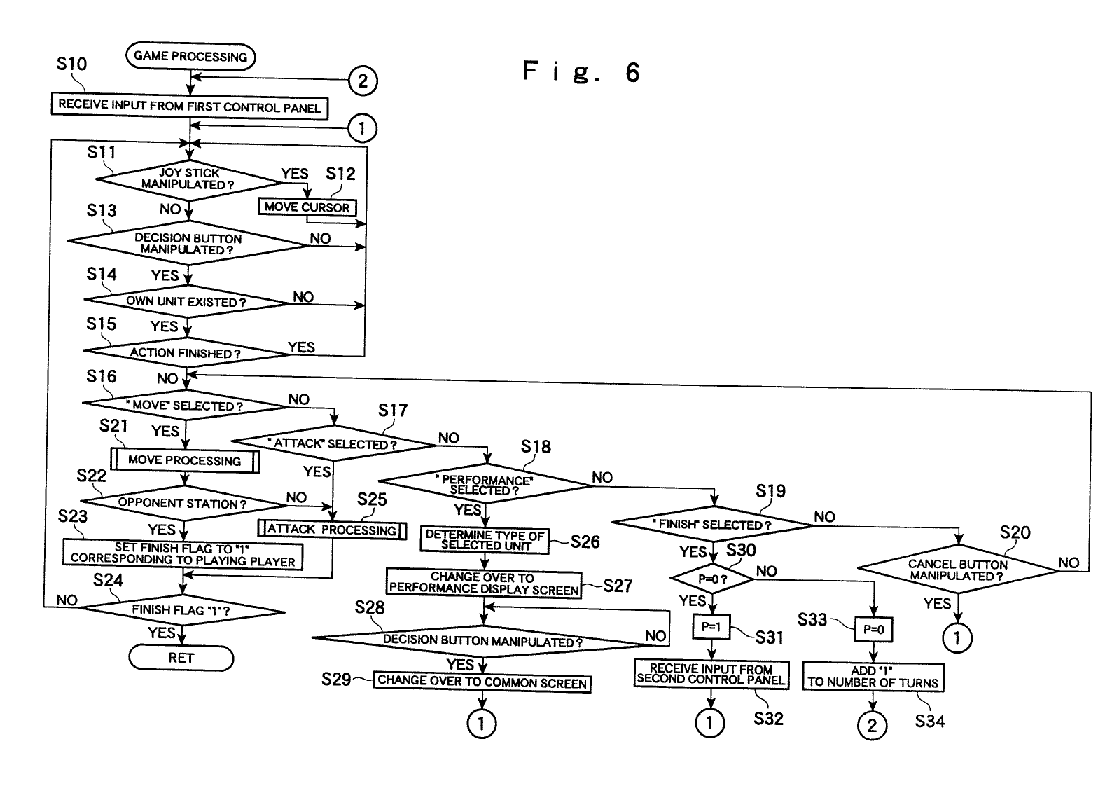

Next, a content of processing relevant to the simulation game which is performed on the above-mentioned gaming machine 1 is explained in conjunction with FIG. 5. FIG. 5 is a flowchart showing a flow of main processing of the simulation game which is performed by the CPU 21 as shown in FIG. 2. First of all, when electricity is supplied to the gaming machine 1, the CPU 21 performs a trouble check of various kinds of devices which are connected via the bus B and an initializing of the RAM 23 such as a clear (step S1). Then, after the initializing is finished, by controlling the VDP 29, the CPU 21 allows the display device 2 to display a demonstration screen (hereinafter, referred to as a demo screen) which shows a title of the simulation game which is performed in the gaming machine 1, the manner of playing and a situation in the play (step S2). Here, the CPU 21 also controls the sound source IC 26, and allows the speakers 3L, 3R to output sound effects which are generated during the demo screen or musical sound from the speakers 3R, 3L.

In this manner, the VDP 29 sequentially forms the demo screen by reading the image data from the image data ROM 28 and writing the image data to the VRAM 30 suitably in accordance with the control of the CPU 21 and, thereafter, the CPU 21 displays the demo screen on the display device 2 via the LCD driver 31. Further, the sound source IC 26 reads vocal or musical sound data from the vocal data ROM 25 in accordance with the control of the CPU21 and, thereafter, the sound source IC26 generates a sound based on the read vocal or the musical sound data from the speakers 3R, 3L via the amplifier 27.

Further, the CPU 21 determines whether the coin is inserted into the coin insertion slot 8 or not (step S3). When the CPU 21 determines that the coin is not inserted, a result of determination is negative, and the CPU 21 continues processing of step S2. Then, when the coin is inserted into the coin insertion slot 8, a result of determination of step S2 is affirmative, and the CPU 21 controls the VDP 29 and the sound source IC 26 for displaying a prologue screen which introduces a world view on the simulation game or a story which exists on the background of a gaming world on the display device 2 and for generating the BOM (step S4). In this manner, the VDP 29 suitably generates the prologue screen and displays on the display device 2 via the LCD driver 31 and, at the same time, the sound source IC 26 outputs the BGM which is played together with the prologue screen from the speakers 3R, 3L.

When the display of the prologue screen described above is finished, the CUP 21 performs gaming processing of the simulation game which is played on the gaming machine 1 in response to the signals outputted from the first and second control panels 4R, 4L corresponding to the control of the first and second players (step S5). Further, as a result of the gaming processing, when the first or second player P1, P2 satisfies a finish condition, the CPU21 displays an ending screen which shows that the simulation game is finished (being described later with respect to contents) (step S6) and, thereafter, performs initializing processing in step S1 again, and performs the display of the demo screen until the coin is inserted into the coin insertion slot 8.

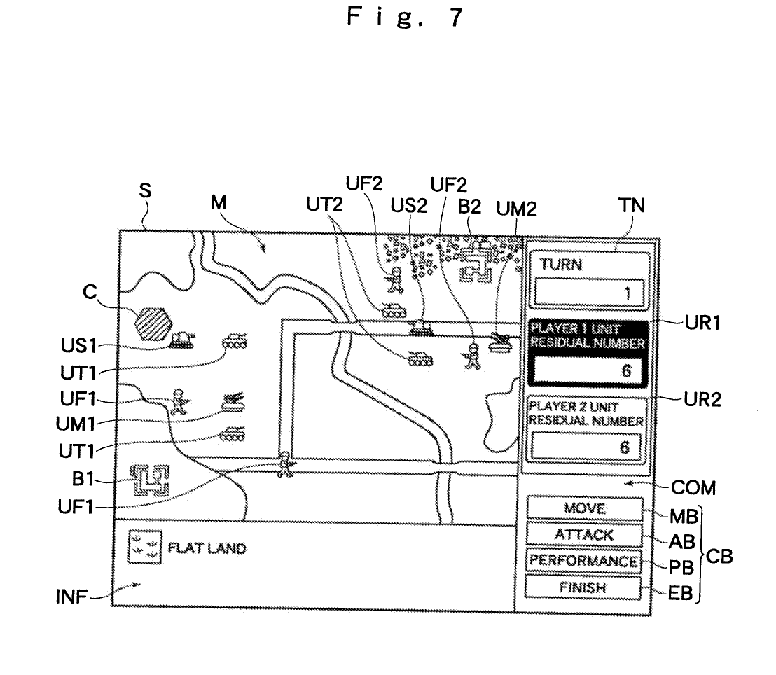

Next, the detailed explanation is made with respect to a flow of detailed processing of game processing executed in step S5 of main processing shown in FIG. 5 in conjunction with FIG. 6. When the processing of step S4 shown in FIG. 5, that is, the display of a prologue screen finishes, the CPU 21 controls the VDP 29 to display the game screen shown in FIG. 7 on the screen of display device 2 and, at the same time, accepts inputting of signals in response to the manipulations of the joy stick 5R, the decision button 6R, and the cancel button 7R which are mounted on the first control panel 4R (step S10).

Here, the explanation is made with respect to contents of the game screen of FIG. 7. First of all, with respect to the inside of the screen S of the display device 2, a map display region M in which a map which constitutes a combat field of the simulation game is displayed is provided substantially in the middle. While topographies such as hills, rivers, flat lands, terrains and roads are displayed in the map, various units and stations allocated to the first and the second players P1, P2 respectively are arranged. For the units, distances which the units can move inside the map, attack forces, ranges of attack, and defense forces are predetermined in accordance with kinds of the units. In FIG. 7, a station unit B, an infantry unit UF, a tank unit UT, an armored artillery unit US, and an anti-aircraft vehicle unit UM are arranged inside the map. In FIG. 7, symbol which is affixed with “1” indicates that the unit indicated by such a symbol is allocated to the first player P1, while symbol which is affixed with “2” indicates that the unit indicated by such a symbol is allocated to the second player P2. Further, the units allocated to the first player P1 correspond to the first objects manipulated by the first control panel 4R, while the units allocated to the second player P2 correspond to the second objects manipulated by the second control panel 4L.

Further, a hexagonal cursor C is displayed inside the map display region M, and the cursor C is moved inside the map display region M by manipulating the joy sticks 5R, 5L thus performing the selection of the units displayed or the like. To be more specific, the selection of the unit is performed by moving the cursor C and overlapping the cursor C to the unit to be selected and by pushing the decision buttons 6R, 6L. Positional information on the above-mentioned respective units inside the map display region M and the cursor C is stored in the RAM 23. The CPU 21 recognizes the position of the respective units and the cursor C by referring to the RAM 23, and when the units and the cursor are moved and manipulated by the player, the positional information on the manipulated units or the cursor C stored in the RAM 23 is updated corresponding to the manipulations.

Below the map display region M, the information display region INF which displays information on the topography of the position where the cursor C is displayed or the units is provided, and in FIG. 7, the position where the cursor C indicates is the flat land. Further, a command display region COM is arranged on the right side of the map display region M. In the command display region COM, a number-of-turns display region TN which displays the number of turns indicative of the progress of the game and the unit residual number display regions UR1, UR2 which indicate residual numbers of unit numbers allocated to the first and the second players P1, P2 respectively are arranged. Here, a simulation game of this embodiment proceeds in such a way that the first player P1 and the second player P2 output instructions with respect to various commands which are described later to the units allocated to the respective players and perform the processing alternately. That is, each turn has top and bottom like baseball. In the top, the first player P1 outputs instructions to the units allocated to the first player P1, and in the bottom, the second player P2 outputs instructions, thus the game proceeds. Here, the number of turns indicates how many turns are played so far. Further in each turn, a background of either one of the unit residual number display regions UR1 and UR2 becomes dark to indicate the turn (hereinafter referred to as phase) which allows either one of the first player P1 and the second player P2 to give the instruction. In FIG. 7, for example, the background of the unit residual number display region UR1 becomes dark and this implies that the turn is the phase of the first player P1.

Below the unit residual number display region UR2, a command button CB to designate various commands with respect to the units selected is displayed in the map display region M. The command button CB is constituted of four buttons including a move button MB, an attack button AB, a performance button SB, and a finish button EB. The move button MB is a button which is selected for moving the selected unit, and the attack button AB is a button which is selected for allowing the unit to attack the opponent unit. Further, the performance button PB is a button which is selected to allow the performance of the selected unit to be displayed on the display device 2, and the finish button EB is a button which is selected to finish own phase and to shift the turn to the phase of the opponent player. The above-mentioned command button CB assumes an input reception state (described later) when a unit is selected in the map display region MB, and under such a condition, it is possible to select the command button CB by manipulating the joy sticks 5R or 5L. When the desired button is selected and the decision button 6R or 6L is pushed, the instruction of the selected command is outputted to the above-mentioned selected unit. Here, with respect to the instruction to the respective units during one phase, only one time to one unit is possible.

As described above, the game screen shown in FIG. 7 includes the map display region M where the behaviors of the units allocated to the first and second players P1, P2 respectively are displayed. This game screen is a screen which displays the contents relevant to both of the first and second players P1, P2 and hence, the screen may be also referred to as a common screen which displays the behaviors of the first and second objects.

Referring back to FIG. 6, in step S10, when the game screen shown in FIG. 7 is displayed on a screen S of the display device 2 and the state which accepts the inputting from the first control panel 4R is established, the CPU 21 determines whether the first joy stick 5R is manipulated or not (step S11). To be more specific, the CPU21 determines whether a signal to instruct either a vertical or horizontal direction from the first joy stick 5R is outputted or not. When the CPU 21 determines that the first joy stick 5R is manipulated, a result of determination is affirmative and the CPU 21 updates the positional information on the cursor C stored in RAM 23 and, at the same time, manipulates the VDP 29 (step S12) to move the display of the cursor C to the instructed direction. The CPU 21 executes steps S11 and S12 in a repeated manner until the first joy stick 5R is no more manipulated. On the other hand, when the CPU 21 determines that the first joy stick 5R is not manipulated, a result of determination is negative and the CPU 21 determines whether the decision button 6R is pushed or not (step S13).

When the CPU21 determines that the decision button 6R is not pushed, a result of determination is negative and the processing returns to step S11 to determine again whether the first joy stick 5R is manipulated or not. On the other hand, when the CPU 21 determines that the decision button 6R is pushed, a result of determination is affirmative and the CPU 21 determines whether the position where the cursor C is presently displayed agrees with the position of any one of the units allocated to the first player P1 (step S14) or not. That is, the CPU 21 determines whether the cursor C and any one of the units allocated to the first player P1 are displayed in an overlapping manner or not. When the CPU 21 determines that the positions where both displayed positions do not agree with each other, a result of the determination s negative and the processing returns to the processing of step S11. On the other hand, when the CPU21 determines that the positions where both displayed positions agree with each other, a result of determination is affirmative and the CPU 21 determines whether a command is already instructed to the unit displayed on the position which agrees with the position where the cursor C is displayed or not, that is, determines whether the unit already finishes the operation (step S15) or not.

When the CPU 21 determines that the unit already finishes the operation in step 15, a result of determination is affirmative and the processing returns to the processing of step S11. On the other hand, when the CPU 21 determines that the unit does not finish the operation yet, a result of determination is negative and the CPU 21 selects and processes the command button CB shown in FIG. 7. That is, the CPU 21 determines whether any one of the move button MB, the attack button AB, the performance button PB, and the finish button EB is selected (steps S16 to S19) or not. Further, with respect to the processing in steps S16 to S19, when none of the command buttons CB is selected, a result of determination is negative and the CPU21 determines whether the cancel button 7R is pushed (step S20) or not. When the CPU 21 determines, in processing step S20, that the cancel button 7R is not pushed, the processing returns to step 16 to determine again whether any one of the command buttons CB is selected or not. On the other hand, when the cancel button 7R is pushed, a result of determination of step 20 is affirmative and the processing returns to step S11 to perform processing again to select the unit. As described above, when the CPU 21 finishes processing in step S15, the CPU 21 is in an input standby state until any one of the command buttons CB is selected or the cancel button 7R is pushed.

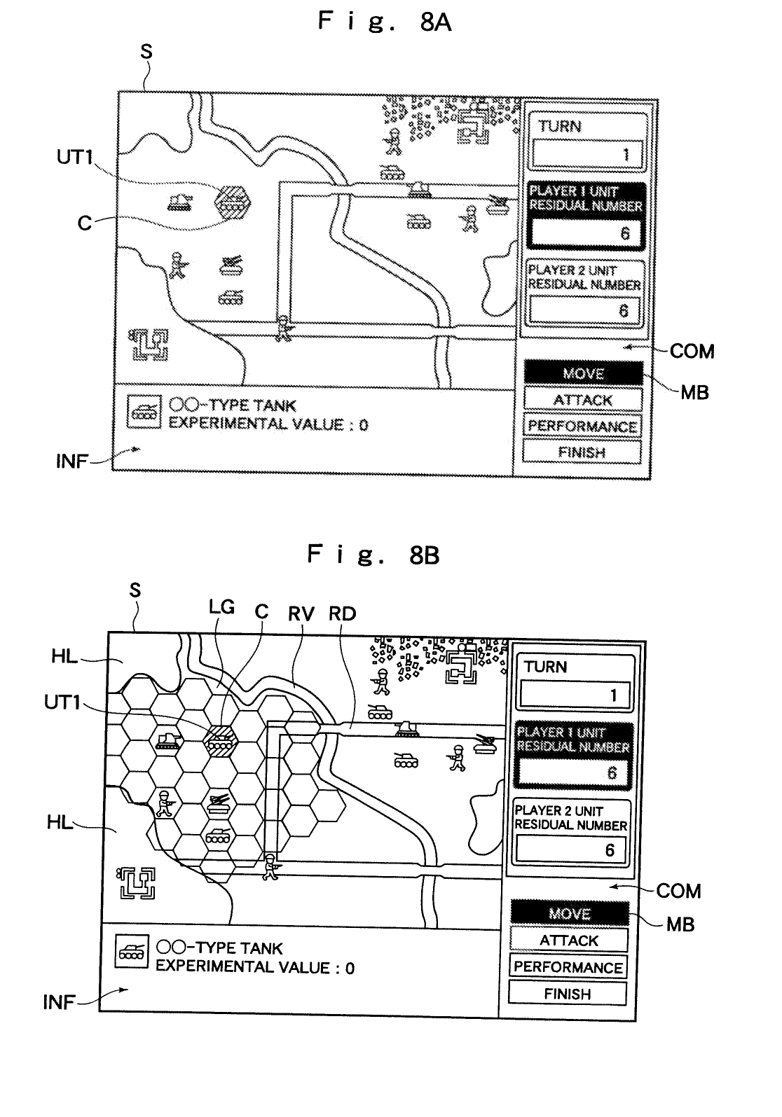

Here, the explanation is made with respect to the selection method of the command button CB in conjunction with the game screen shown in FIG. 8A. First of all, when a position of the cursor C shown FIG. 7 is moved to a position of the tank unit UT1 shown in FIG. 8A by manipulating the joy stick 5R, a name of the tank unit UT1 (-type tank) used in the game and experimental values of the tank unit UT1 are displayed in the information display region INF. When the decision button 6R is pushed under such a condition, first of all, the background of the move button MB out of the displays of the command buttons CB becomes dark as shown in FIG. 8A. When the decision button 6R is pushed at this moment, this implies that the first player P1 selects the move button MB as a command for the tank unit UT1, and a result of determination of step S16 is affirmative, and the processing advances to a move processing in step S21. Further, when the joy stick 5R is manipulated downwardly in a state that the background of the move button MB is darkened, the background of the move button MB returns to the original state and the background of the attack button AB is darkened. When the decision button 6R is pushed at this moment, a result of determination of step S17 becomes affirmative, and the processing advances to combat processing in step S25. In this manner, a background-darkening-button is sequentially moved by manipulating the joy stick 5R. When the decision button 6R is pushed when the background of a desired button becomes dark, this implies that the command button CB is selected. Further, when the cancel button 7R is pushed, the display of the button whose background is darkened returns to a non-dark state (the ordinary display condition), and the processing returns to the processing of step S11.

Next, the explanation is made with respect to the content of processing which is executed when any one of the command buttons CB is selected during the execution of processing of steps S16 to S19 for every kind of the selected command button CB.

1. The case in which the move button MB is selected

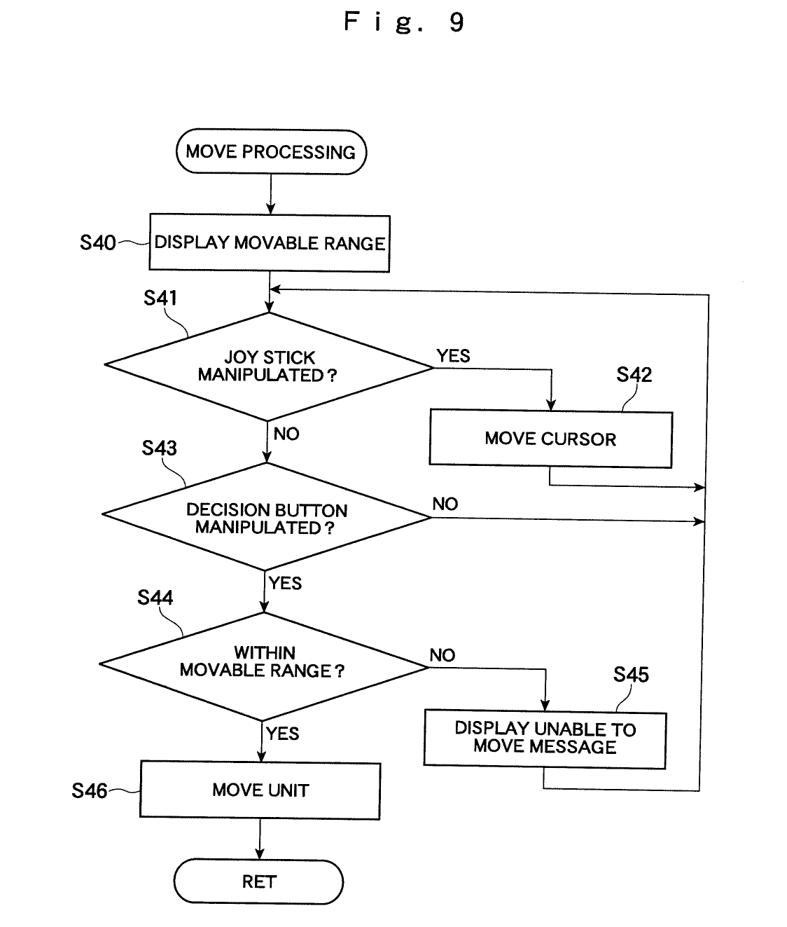

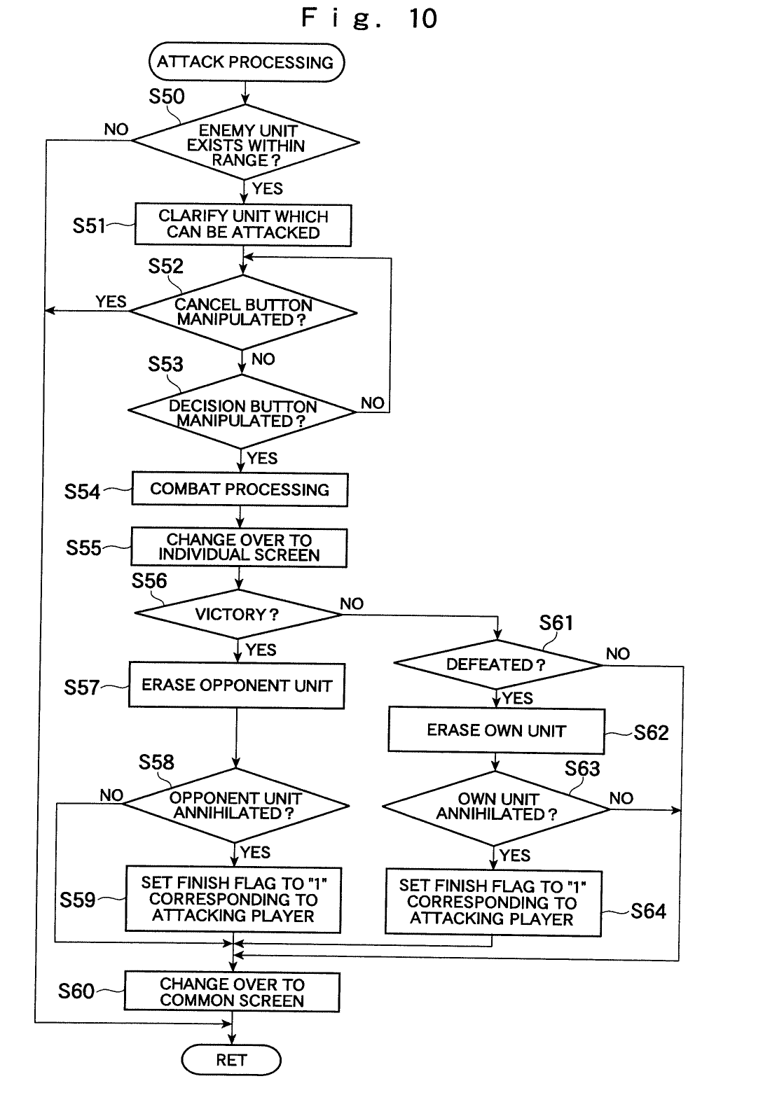

When the move button MB is selected by the first player P1 and a result of determination of step S16 is affirmative, the CPU 21 executes, first of all, move processing of the selected unit (step S21). The explanation is made with respect to the contents of the move processing in conjunction with a flow chart shown in FIG. 9.

When the processing advances to the move processing shown in FIG. 9, the CPU 21 makes the VDP 29 display a movable range of the selected unit in the map display region M (step S40). The movable range is displayed with a plurality of hexes (hexagonal pieces) and the size of the range is decided by a moving force and topography which are preliminarily set in the respective units. For example, FIG. 8B shows a movable range when a moving force of “1” is required to go one hex in the flat land LG or the road RD, and a moving force of “2” is required to go one hex on the hill HL, while the moving force of the tank unit UT1 is determined to be “4” on the premise that the tank unit UT1 cannot invade the river RV.

When the movable range of the unit selected in step S40 is displayed, the CPU 21 determines whether the first joy stick 5R is manipulated or not (step S41). When the CPU 21 determines that the first joy stick 5R is manipulated, a result of determination is affirmative and the CPU 21 updates the positional information on the cursor C stored in the RAM 23 and, at the same time, controls the VDP 29 to move the display of the cursor C in the instructed direction (step S42). The CPU 21 performs processing of steps S41 and S42 in a repeated manner until the first joy stick 5R is not manipulated. On the other hand, when the CPU 21 determines that the first joy stick 5R is not manipulated, a result of determination is negative and the CPU 21 determines whether the decision button 6R is pushed or not (step S43). When the CPU 21 determines that the decision button 6R is not pushed, a result of determination is negative, and the processing returns to step S41, where the CPU 21 determines again whether the first joystick 5R is manipulated or not.

On the other hand, when the CPU 21 determines that the decision button 6R is pushed, a result of determination is affirmative and the CPU 21 determines whether the position where the cursor C is displayed at the moment when the decision button 6R is pushed is within the movable range displayed in step S40 or not (step S44). When the position where the cursor C is displayed is outside the movable range, a result of the determination is negative, and a message “unable to move” is displayed in the information display region INF for a predetermined time (step S45), and the processing returns to the processing of step S41. Further, even within the movable range, the cursor C cannot move to the position where an own or an opponent unit is positioned, and also in this case, a result of determination of step S44 is negative. To the contrary, when the cursor C is within the movable range, a result of determination is affirmative, and the CPU 21 makes the VDP 29 move the display of the selected unit to the position of the cursor C and, at the same time, updates the positional information on the selected unit stored in the RAM 23 to the positional information after the movement (step S46). When the CPU21 finishes processing of step S46, the CPU 21 finishes the move processing (that is, the processing of step S21 in FIG. 6) and advances to the processing of step S22 shown in FIG. 6.

In step S22 in FIG. 6, the CPU 21 determines whether the position of the unit after the movement agrees with the position where the station unit B of the opponent (in this case, the second player P2) is displayed or not. When the position where the selected unit is displayed after the movement does not agree with the position where the station unit B of the opponent is displayed, the CPU21 shifts to the combat processing described later. To the contrary, when the position where the selected unit is displayed after the movement agrees with the position where the station unit B of the opponent is displayed, the result of determination is affirmative and the player who is playing presently (in this case the first player P1) is determined to satisfy the finish condition and hence, the finish flag (in this case END1) which corresponds with the player is changed to “1” (step S23). Further, with respect to the above-mentioned finish flag, a finish flag (END2) which corresponds with the second player P2 is also prepared. When the second player P2 satisfies the finish condition, the finish flag END2 is changed to “1”.

Next, when the combat processing in step S23 or step S25, which will be described later, is finished, the CPU determines whether either one of the finish flag END1 or END2 is changed to “1” or not(step S24). When neither the finish flag END1 nor END2 is changed to “1”, the result of determination is negative, and the processing returns to the above-mentioned processing in step S11. On the other hand, when the finish flag END1 or END2 is changed to “1”, the result of determination is affirmative, and the game processing in FIG. 6 is finished, and the processing advances to the processing in step S6 in the main processing in FIG. 5. In step S6 in FIG. 5, the ending screen corresponding to the finish flag which is changed to “1” is displayed on the display device 2. For example, when the finish flag END1 is changed to “1”, the first player P1 wins, and the ending screen celebrating the victory is displayed. When the finish flag END2 is changed to “1”, the second player wins, and the ending screen celebrating the victory is displayed.

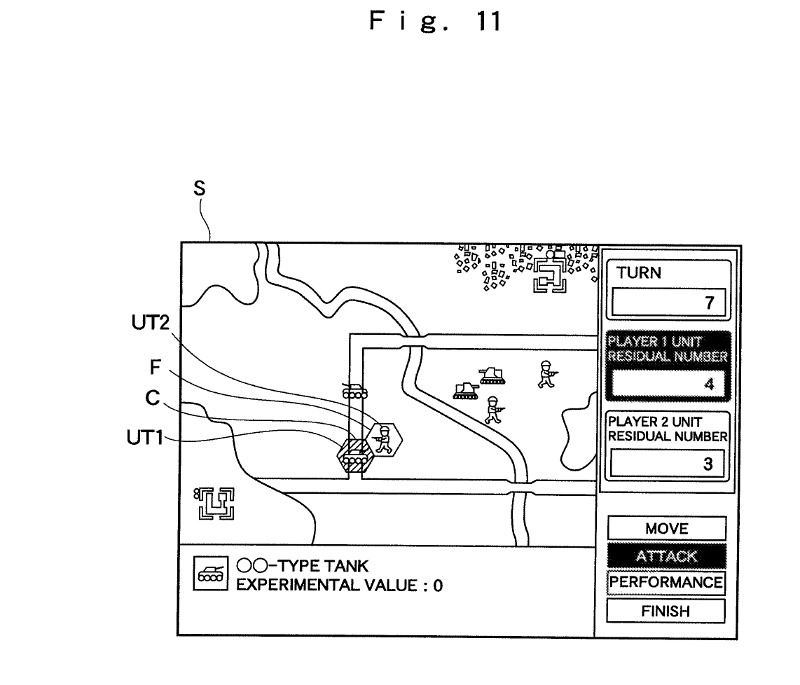

(2) The case in which the attack button AB is selected When the attack button AB is selected by the first player P1 and the result of determination of step S17 in FIG. 6 is affirmative or the above-mentioned result of determination of step S22 is negative, the CPU 21 executes the attack processing (step S25). The explanation is made with respect to the contents of the attack processing in conjunction with the flow chart shown in FIG. 10.

In step S50 in FIG. 10, the CPU 21 determines whether an opponent unit exists within the range of attack of either the unit selected at the moment or the unit which has just finished moving or not by reference to the positions of respective units inside the map display region M which is stored in the RAM 23. Here, the attack range is the predetermined distance for each unit which allows an attack against the opponent unit. The attack range is determined by the number of hexes between an own unit and an opponent unit. For example, a unit whose attack range is determined “1” is capable of attacking an opponent unit which exists in a hex adjacent to a hex where an own unit is positioned. Accordingly, the CPU 21 constitutes a game control unit which determines the relative distance inside the gaming space between the first object (that is, the unit allocated to the first player P1) and the second object (that is, the unit allocated to the second player P2).

When no opponent unit exists within the attack range of either the unit selected at the moment or the unit which finishes moving, the result of determination in step S50 is negative and the attack processing in FIG. 10 is finished, and the processing advances to step S24 of game processing shown in FIG. 6. Accordingly, when the position of the unit is not on the station unit of the opponent after the movement of the unit (FIG. 6, step S22, NO) and no opponent unit exists within the attack range after the movement of the unit (FIG. 10, step S50, NO), neither one of the finish flags is changed to “1” and hence, the result of determination of step S24 in FIG. 6 is negative, and the processing returns to the processing of step S11 which is the processing to select the unit again. On the other hand, when an opponent unit exists within the attack range of either one of the unit selected at the moment and the unit which finishes moving, the result of determination of step S50 is affirmative and, as shown in FIG. 11, the CPU 21 makes the VDP 29 display a frame line F which surrounds the opponent unit existing within the attack range thus clearly indicating the unit which can be attacked (step S51).

FIG. 11 shows that the infantry unit UF2 which is allocated to the second player P2 exists within the attack range (The attack range of the tank unit UT is determined to be “1”) of the tank unit UT1 which is allocated to the first player P1. Under such circumstances, the CPU 21 subsequently determines whether the first cancel button 7R is pushed or not (step S52). When the CPU 21 determines that the first cancel button 7R is pushed, the result of determination is affirmative and the CPU 21 finishes the attack processing in FIG. 10 to advance to step S24 of the game processing shown in FIG. 6. On the other hand, when the CPU 21 determines that the first cancel button 7R is not pushed, the result of determination is negative and the CPU 21 determines whether the first decision button 6R is pushed or not (step S53). When the CPU 21 determines that the first decision button 6R is not pushed, the result of determination is negative, and the processing returns to step S52. Thereafter, the CPU repeats the processing of steps S52 and S53 until either one of the first cancel button 7R and the decision button 6R is pushed.

When the first decision button R6 is pushed, the result of determination of step S53 is affirmative and the CPU 21 executes the combat processing (step S54). In the combat processing, the CPU 21 reduces the respectively predetermined values of the defense force based on the values of the attack force which are respectively predetermined for the unit which attacks and the unit which is attacked and random numbers. Further, the CPU 21 reduces the values of the attack forces in response to the reduced defense force. Still further, based on how much the defense force of the opponent unit is reduced, the experimental values of the respective units are increased. The CPU 21 updates the values of the attack force, the defense force, and the experimental values which are stored in the RAM 23 in response to the unit which attacks and the unit which is attacked to the values which are obtained by the combat processing.

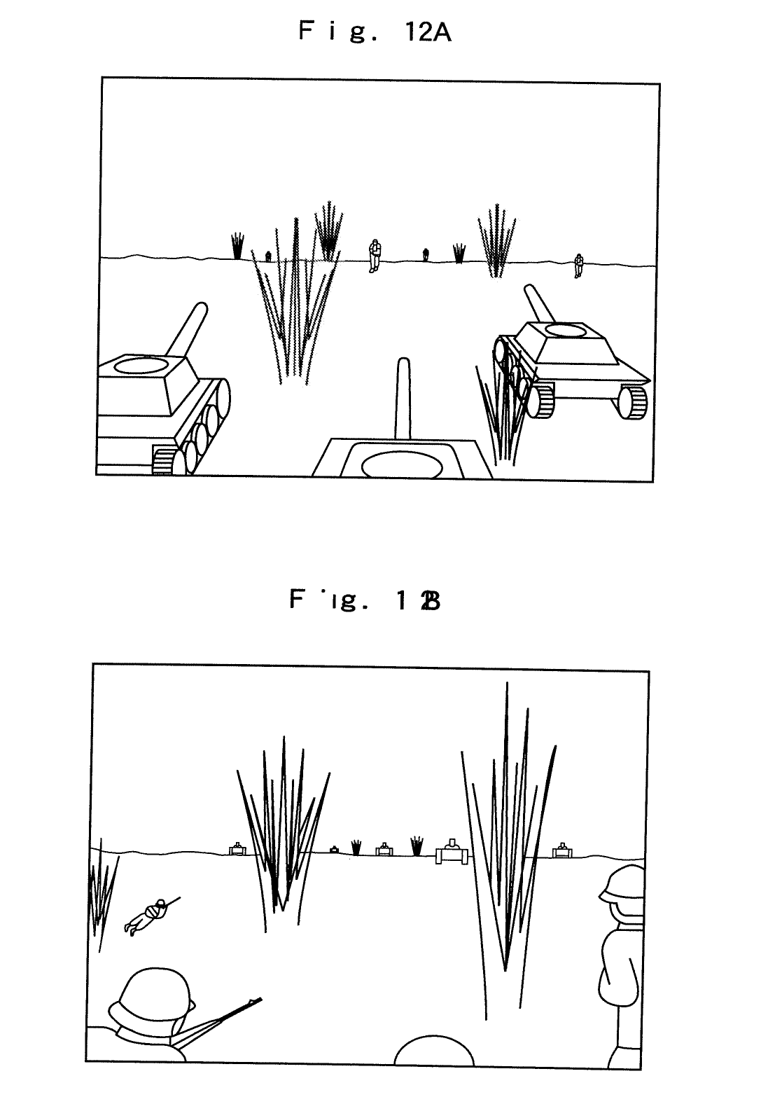

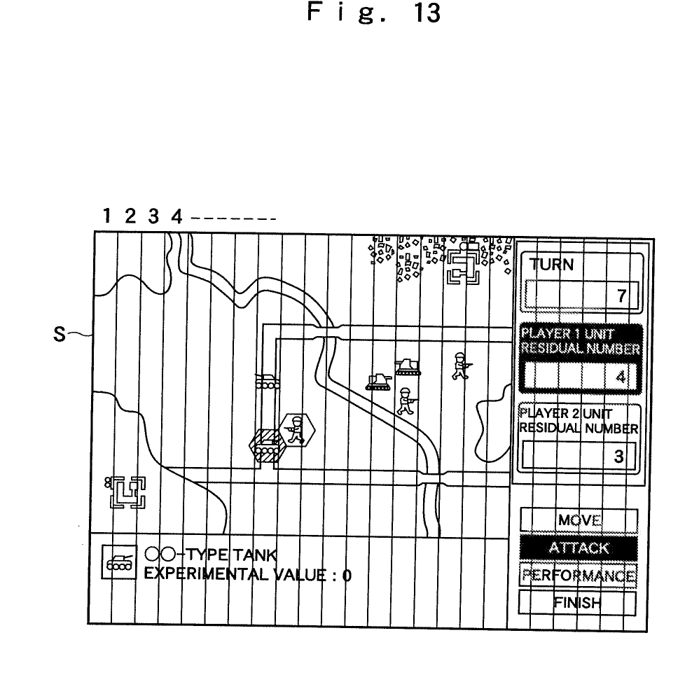

In the above-mentioned steps up to step S54, to the first and second players P1, P2, the CPU 21 displays the units which correspond to each player on one screen and displays the game screen of the same content showing the gaming situation common to both players (that is, common screen) on the display device 2 as shown in FIG. 7, FIG. 8 and FIG. 11. Then, the CPU 21 controls the VDP 29 so as to ask the respective players to change over the screens which are observed when the players observe the world in the map from viewpoints of units allocated to the respective players (that is, individual screens) (step S55). For example, as shown in FIG. 11, the CPU 21 controls the VDP 29 such that when the tank unit UT1 of the first player Pi attacks the infantry unit UF2 of the second player P2, the image of the map world when the infantry unit UF2 is observed from the tank unit UT1 is displayed to the first player P1 as shown in FIG. 12A, and the image of the map world when the tank unit UT1 is observed from the infantry unit UF2 is displayed to the second player P2 as shown in FIG. 12B. Further, the image shown in FIG. 12A corresponds to the first image which indicates the game situation relevant to the first player P1 (in this case, the status that the tank unit UT1 enters a combat state with the infantry unit UF2), and the image shown in FIG. 12B corresponds to the second image which indicates the game situation relevant to the second player P2 (in this case, the status that the infantry unit UF2 enters a combat state with the tank unit UT1).

Here, the principle of displaying the above-mentioned common screen and individual screens on the display screen 2 is explained. First of all, when the common screen shown in FIG. 11 is displayed, the VDP 29 directly writes the image data for displaying the common image in respective addresses of the VRAM 30 without modification. In this case, as shown in FIG. 13, out of the images displayed on the screen S of the display device 2, the first player P1 observes the image displayed on the odd-numbered pixel rows and the second player P2 observes the image displayed on the even-numbered pixel rows. Here, numerals 1, 2, 3, 4, . . . in FIG. 13 indicate the numbers of the pixel rows in the screen of the display device 2, wherein an image which is to be displayed over a plurality of pixel rows originally is illustrated in one pixel row for facilitating the understanding of the present invention.

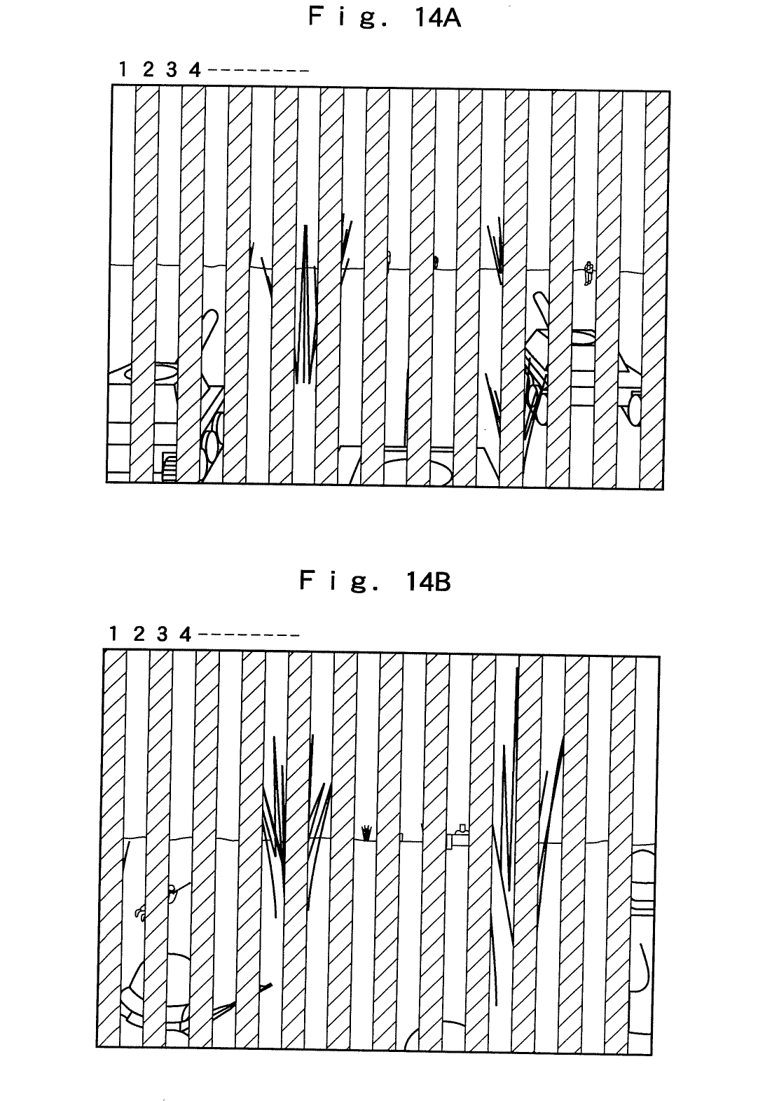

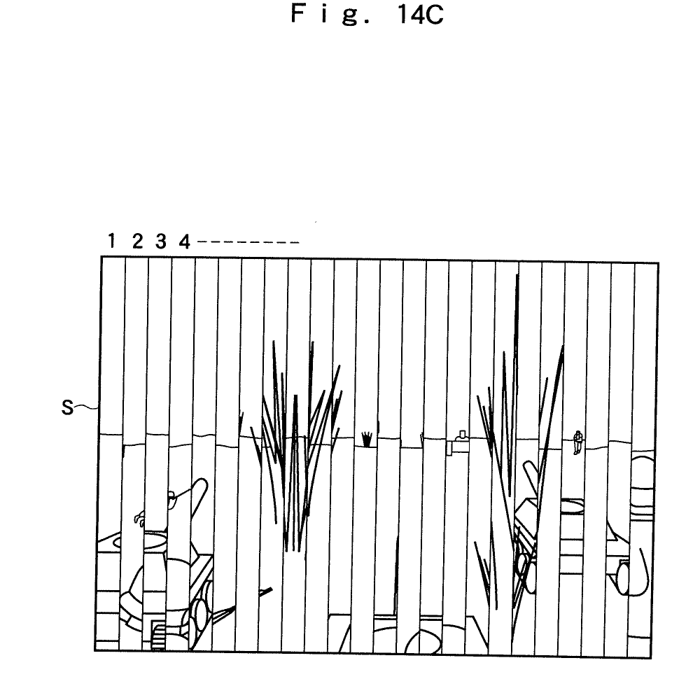

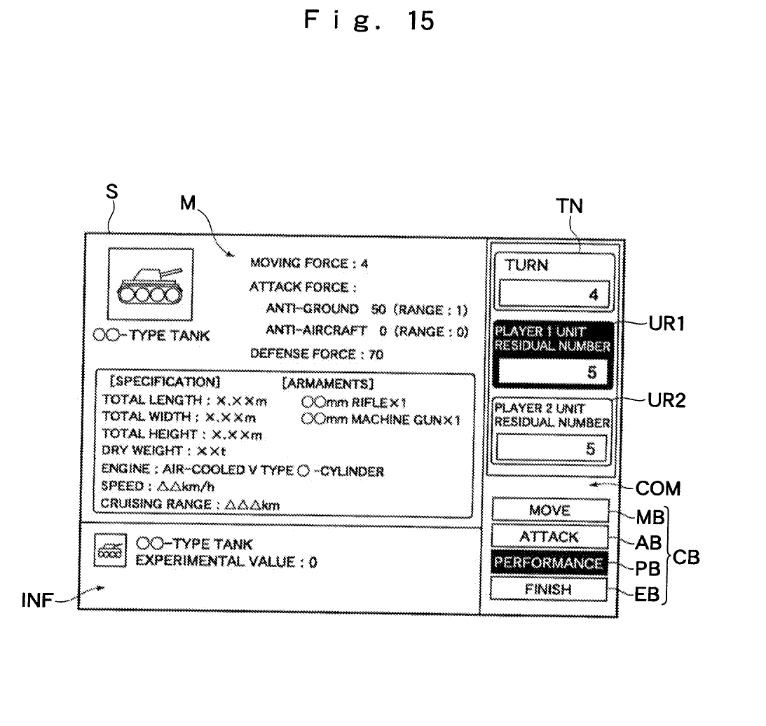

To the contrary, in displaying the individual screens, with respect to the first image shown in FIG. 12A , the VDP 29 writes the image data to be displayed on odd-numbered pixel rows in corresponding addresses of the VRAM 30 as shown in FIG. 14A. Further, with respect to the second image shown in FIG. 12B, the VDP 29 writes the image data to be displayed on even-numbered pixel rows in corresponding addresses of the VRAM 30 as shown in FIG. 14B. With respect to the image formed in this manner, on the display screen of the display device 2, as shown in FIG. 14C, the first image to be displayed on the odd-numbered pixel rows and the second image to be displayed on the even-numbered pixel rows are alternatively displayed. Here, with the provision of the parallax barrier 150 shown in FIG. 2, the first player P1 observes only the first image portion and the second player P2 observes only the second image portion. Here, numerals 1, 2, 3, 4, . . . in FIG. 14 indicate the numbers of the pixel rows in the screen of the display device 2, wherein, in the same manner as FIG. 13, an image which is to be displayed over a plurality of pixel rows originally is illustrated in one pixel row for facilitating the understanding of the present invention.

In this manner, the VDP 29 corresponds to a display control unit which changes over the common screen and the individual screens corresponding to a relative distance of the first and second objects which are determined by the CPU21. Here, provided that the respective individual images shown in FIG. 12 are images which show that the objects enter a combat state, the images may be formed of either a still image or a motion picture image. Further, corresponding to a result of the combat processing in step S54, the combat state may be displayed by changing over a plurality of still images or by a motion picture image such as the reduction of the numbers of the displayed infantries and tanks.

When the display is changed over from the common screen to the individual screens by the VDP 29 as described above, it is determined whether a value of a defense force of the unit which becomes an object to be attacked (the infantry unit UF2 in case of FIG. 11) becomes “0” or not (step S56). When the value of the defense force is “0”, the determination result becomes affirmative, and various data on the unit which becomes the object to be attacked such as position information, an attack force, a defense force of the unit in the map stored in the RAM 23 is erased (step S57). As a result, it is determined whether all of data on the attacked side, that is, the unit of the second player P2 in FIG. 11 is erased from the RAM 23 or not (step S58). When all of such data is erased, it is considered that the attack side, that is, the first player P1 satisfies the finish condition and a finish flag END1 is set to “1” (step S59). When the processing in step S59 is executed or when all of data on the unit of the player on the attacked side is not erased from the RAM 23 and the determination result in step S58 becomes negative, the CPU 21 controls the VDP 29 such that the common screen is displayed on the display device 2 in a state that the display of the unit erased in step S57 is eliminated (step S60). In this case, the display of the infantry unit UF2 is erased from the game screen shown in FIG. 11 and, at the same time, the game screen in a state that the number of the remaining units of the second player P2 which is displayed on the unit residual number display region UR2 is reduced by one is displayed.

On the other hand, when the value of the defense force of the unit which becomes an object to be attacked is not “038 in step S56, the determination result becomes negative, it is determined whether the value of the defense force of the attacking unit (the tank unit UT1 in case of FIG. 11) becomes “0” or not (step S61). When the value of the defense force is “0”, the determination result becomes affirmative, and various data on the attacking unit in the RAM 23 is erased (step S62). As a result, it is determined whether all of data on the attack side, that is, the unit of the first player P1 in case of FIG. 11 is erased from the RAM 23 or not (step S63). When all of such data is erased, it is considered that the attacked side, that is, the second player P2 satisfies the finish condition and a finish flag END2 is set to “1” (step S64). When the processing in step S64 is executed or when all of data on the unit of the player on the attack side is not erased from the RAM 23 and the determination result in step S63 becomes negative, the CPU 21 controls the VDP 29 such that the common screen is displayed on the display device 2 in a state that the display of the unit erased in step S62 is eliminated (step S60). In this case, for example, the display of the tank unit UT1 is erased from the game screen shown in FIG. 11 and, at the same time, the game screen in a state that the number of the remaining units of the first player P1 which is displayed on the unit residual number display region UR1 is reduced by one is displayed.

Further, when the value of the defense force of the attacking unit is not “0” in step S61, that is, when both values of the defense forces of the attacking unit and the defense force of the attacked unit are not “0” in the combat processing of this time, a state of the game screen before the game screen is changed over to the individual screen is continuously displayed on the display device 2.

When the attack processing shown in FIG. 10 is finished by performing the above-mentioned processing, the processing advances to step S24 in the game processing shown in FIG. 6, and it is determined whether the finish flag END1 or END2 is “1” or not. When neither one of the finish flags is “1”, the determination result becomes negative, and the processing returns to step S11 shown in FIG. 6. On the other hand, while either of the finish flags is “1”, the determination result becomes affirmative, and the game processing in FIG. 6 is finished and the processing advances to step S6 in the main processing in FIG. 5. Then, in step S6 in FIG. 5, as described above, the ending screen corresponding to the finish flag which is “1” is displayed on the display device 2.

(3) The case in which performance button PB is selected

When a performance button PB is selected by the first player P1 and a result of a determination of step S18 of FIG. 6 is affirmative, the CPU21 determines a kind of the unit which is selected by the cursor C (step S26). Then, the CPU 21 controls the VDP 29 and allows the display device 2 to display a performance display screen which corresponds to a kind of the determined unit (step S27). Here, contents displayed on the performance display screen are explained in conjunction with FIG. 15. FIG. 15 shows the performance display screen when the tank unit UT1 is selected in the map display region M. In the drawing, on an upper left side of the map display region M, an image and a name of the selected unit are displayed, while on a right side of the map display region M, as the performances of the selected unit, a moving force, an attack force and an attack range and, a defense force in the map are displayed. Further, below these displays, the specification and the armament of the selected unit are displayed.

Next, the CPU 21 determines whether the determination button 6R is pushed or not (step S28). If the button is not pushed, a result of the determination is negative, and a standby state is held until the determination button 6 is pushed. Then, when the determination button 6R is pushed, a result of the determination of step S28 is affirmative, and the CPU 21 controls the VDP 29 so as to return the screen to a gaming screen which is the screen before the screen is shifted to the performance display screen (step S29). Thereafter, the processing returns to step S11 and, again, the processing to select a unit again is performed in the map display region M.

(4) The case in which finish button EB is selected

When the finish button BE is selected by the first player P1 and a result of a determination of step S19 of FIG. 6 is affirmative, the CPU 21 determines whether the first player P1 is in a phase now or not, that is, whether the phase flag P assumes “0” or not (step S30). When the phase flag P assumes “0”, that is, when the first player P1 is in the phase, the result of determination is negative, and the phase of the first player P1 is finished and hence, the phase flag P is set to “1” so as to shift the phase to the phase of the second player P2 (step S31). Then, in the succeeding processing, inputs from the first joy stick 5R, the first determination button 6R and the first cancel button 7R are ignored, while inputs from a second joy stick 5L, a second determination button 6L and a second cancel button 7L are accepted. Then, processing in step S11 and steps succeeding step S11 are executed in response to the manipulation by the second player P2.

Thereafter, the second player P2 performs the manipulation using the second joy stick 5L, the second determination button 6L or the second cancel button 7L to allow the own respective units to perform the movement, the attack or the like. When the finish button EB is selected, since the phase flag P assumes “1” in the processing in step S30, a result of the determination is negative, and the CPU 21 finishes the phase of the second player P2 and hence, the phase flag P is reset to “0” so as to shift the phase to the phase of the first player P1 (step S33). Then, after adding “1” to a value of the number of turns (step S34), the CPU 21 allows the VDP 29 to display the value in the number-of-turns display region TN shown in FIG. 7. Then, returning to step S10, inputs from the second joy stick 5L, the second determination button 6L and the second cancel button 7L are ignored, while inputs from the first joy stick 5R, the first determination button 6R and the first cancel button 7R are accepted. Then, processing in step S11 and steps succeeding step S11 are executed in response to the manipulation by the first player P1.

As has been explained heretofore, in the simulation game executed on the gaming machine 1, as shown in FIG. 7, FIG. 8 and FIG. 11, the game is advanced by alternately manipulating own respective units which are respectively allocated to the first player P1 and the second player P2 in the common screen displayed on one map display region M. Then, when the other unit exists in a range of attacks of one unit, the attack becomes possible. When the attack is performed, as shown in FIG. 12A and FIG. 12B, the individual screens which are allowed to perform a display of an image of the map world as viewed from a viewpoint of one unit and an image of the map world as viewed from a viewpoint of the other unit individually to the respective players are displayed on the whole screen of the display device 2. Accordingly, respective players are allowed to view only the image indicative of the own gaming situation, and it is impossible to view a gaming situation of opponent. Due to such a constitution, when the individual screen is displayed, due to the single display device, not only an image with highly vivid presence can be displayed to respective players but also a case that the image displayed to one player becomes difficult to view attributed to the image displayed to the other player does not exist. Further, when the common screen is displayed, in the same manner as the conventional display device, one image is directly displayed on the display device without modification and hence, it is possible to reduce a burden on the processing for displaying the image compared to a case in which the individual screen is displayed.

Due to the above-mentioned embodiments, the following gaming machine can be realized.

(1) The gaming machine including the first input unit (for example, the first control panel 4R) to which instructions from the first player P1 are inputted, the second input unit (for example, the second control panel 4L) to which instructions from the second player P2 are inputted, the storing unit (for example, the ROM 22) which stores the program for executing the game which is played by the first player P1 and the second player P2, the game control unit (for example, the CPU 21) which controls the game by reading the program from the storing unit and by performing processing in response to the instructions which are inputted into the first and the second input unit in accordance with the programs, wherein the gaming machine includes the display device 2 which has the screen which displays images indicative of the situation of the game controlled by the game control unit and is capable of displaying the first image (for example, the image shown in FIG. 12A) which is visible from the first direction and is not visible from the second direction which differs from the first direction on the screen and the second image (for example, the image shown in FIG. 12B) which is visible from the second direction and is not visible from the first direction on the screen, and the display control unit (for example, the VDP29) which performs the control to allow the display device to display the situation of the game relevant to the first player P1 as the first image and the situation of the game relevant to the second player P2 as the second image.

Here, “input unit (for example, the first control panel 4R, the second control panel 4L)” is a unit for a player to manipulate the game and is constituted of, for example, a push-button switch, a rotary switch, or a so-called joy stick, or combination of these units. Further, “game” is not particularly limited provided that the game is conventionally realized using the display device and a plurality of players can participate in the game and is a game belongs to a variety of genres, for example, a card game such as cards, flower cards or Mahjong, a so-called fighting game, a game imitating various kinds of sports, a racing game imitating a car race, a role playing game, a shooting game, a simulation game, a music game (rhythm game) or a quiz game. Further, “first direction” and “second direction” are directions which are preliminarily determined on the display device and may have a predetermined angle range. Further, “an image indicative of gaming situation on the player” indicates, for example, in a case of the card game, an image showing cards in hand corresponding to each player, and in a game which displays an animal or an object corresponding to each player is displayed in the image showing the gaming situation, an image of the inside of the gaming space as viewed from the animal or the object, an image showing the condition of the animal or the object (for example, in a role playing game, own position in the gaming space, a so-called hit point, a damage point, or residual fuel amount of own vehicle in a car race game or the like) or the like.

According to the gaming machine in the above-mentioned (1), the first image showing the gaming situation relevant to the first player and the second image showing the gaming situation relevant to the second player are displayed on one display device and, at the same time, the first image is visible from the first direction and is not visible from the second direction and the second image is visible from the second direction and is not visible from the first direction. Accordingly, by suitably selecting setting positions of seats seated by the first and the second players or setting positions of the first and the second input units, the first player is allowed to view the screen on the display device from the first direction and the second player is allowed to view the screen on the display device from the second direction and hence, each player can only view the image showing gaming situation relevant to the player per se and can not view the gaming situations relevant to his/her opponent. Accordingly, it is unnecessary to provide display devices corresponding to respective players and, at the same time, the present invention can prevent the situation in which the player has difficulty in viewing the image showing the gaming situation relevant to the player per se due to the image showing the gaming situation relevant to another player.

(2) Further, in the above-mentioned gaming machine, the game executed by the program is a game which is advanced in the gaming space by a behavior of a first object (for example, a station unit B1, a infantry unit UF1, a tank unit UT1, an armored artillery unit US1, or anti-aircraft vehicle unit UM1) which is manipulated by the first player P1 and a behavior of a second object (for example, a station unit B2, a infantry unit UF2, a tank unit UT2, an armored artillery unit US2, or anti-aircraft vehicle unit UM2) which is manipulated by the first player P1. The gaming control unit produces the gaming space (for example, a map) and controls of respective behaviors of the first and the second objects in the gaming space based on the instruction inputted from the first and the second input units and, at the same time, grasps the respective positions of the first and the second objects in the gaming space whereby determining a relative distance between the first and the second objects in the gaming space. The display control unit changes over, corresponding to the relative distance between the first and the second objects in the gaming space, between a common screen which show behaviors of the first and the second objects in the gaming space and an individual screen in which the image of the inside of the gaming space as viewed from the first object is displayed as the first image and the image of the inside of the gaming space as viewed from the second object is displayed as the second image.

Here, “object” is an object of manipulation by each player using the input unit and, for example, is a player when the game is a game imitating sports or a man, animal, or an article corresponding to the player when the game is a role playing game. Further, “gaming space” indicates an imaginary space in which the game is performed and, for example, is a sports field of sport when the game is a game imitating a sport game, a circuit when the game is a car race game or a maze when the game is a so-called dungeon type role playing game. Further, “the game which is advanced by the behaviors of the objects” indicates that, for example, the game (here, a baseball game) is advanced corresponding to the behaviors of baseball players (objects) in a baseball field which constitutes a gaming space such as “throwing a ball”, “catching the ball”, “hitting the ball”, “run” or the like when the game is a game imitating baseball, or the game (here, a car race) is advanced in response to the behaviors of cars possessed by the respective players such as “accelerating”, “braking”, “turning” or the like when the game is the car race. Further, “image of the inside of the gaming space as viewed from the first object (or the second object)” includes, in addition to an image of the inside of the gaming space in one direction as viewed from the viewpoint of the first object (here, the first object is not included in the inside of the displayed image), an image of the inside of the gaming space in one direction as viewed from behind the first object (here, the first object is included in the inside of the displayed image). Further, “changes over the screen between a common screen” and “an individual screen” and “corresponding to the relative distance between the first and the second objects” indicate that, for example, when it is determined that the relative distance of the first object and the second object in the gaming space becomes shorter than the predetermined distance by the game control unit, the game control unit changes over the screen which has been displaying the common screen to the individual screen. Here, the screen which has been displaying the individual screen may be changed over to the common screen. Further, when the relative distance between the first object and the second object becomes longer than the predetermined distance, it may be configured such that the common screen is changed over to the individual screen or the individual screen is changed over to the common screen.

According to the gaming machine in the above-mentioned (2), corresponding to the relative distance between the first object which is manipulated by the first player and the second object which corresponds to the second player in the gaming space, the common screen is displayed to the first and the second directions. Accordingly, it is possible to reduce a burden on processing for displaying the image compared to the case in which the individual images of the gaming space as viewed from the viewpoints of the first and the second objects (individual screen) are displayed.

Here, although the above-mentioned embodiment is explained using the simulation game as an example, the embodiment is applicable to a game which belongs to another genre provided that the game is a game in which a plurality of players can participate. Further, the number of participating players is not limited to two, and it is possible to suitably increase the number of the players according to the number of screens which the dual view liquid crystal can simultaneously display. Further, in this embodiment, when the relative distance between the first object and the second object in the gaming space becomes shorter than the predetermined distance, the common screen is changed over to the individual screen. However, corresponding to the contents of the game, the individual screen may be always displayed without changing over between the common screen and the individual screen. Further, contrary to this embodiment, it may be configured such that the individual screen is changed over to the common screen when the relative distance between the first object and the second object in the gaming space becomes shorter than the predetermined distance.

According to the gaming machine of the present invention, the gaming machine allows one player to observe a gaming image which is displayed for one player without being influenced by a gaming image which is displayed for another player in executing a game in which a plurality of players can play, and can reduce an installation cost and an installation space.

What is claimed is:

1. A gaming machine comprising:
a first input unit to which instructions from a first player are inputted;
a second input unit to which instructions from a second player are inputted;
a storing unit which stores a program for executing a game which is played by the first and the second players;
a game control unit which controls the game by reading the program from the storing unit and by performing processing in response to the instructions which are inputted into the first and the second input unit in accordance with the programs, wherein
the gaming machine includes
a display device which has a screen which displays images indicative of a situation of the game controlled by the game control unit and is capable of displaying a first image which is visible from a first direction and is not visible from a second direction which differs from the first direction on the screen and a second image which is visible from the second direction and is not visible from the first direction on the screen; and
a display control unit which performs a control to allow the display device to display the situation of the game relevant to the first player as the first image and the situation of the game relevant to the second player as the second image.

2. A gaming machine according to claim 1, wherein
the game which is executed by the programs is a game which advances in a gaming space due to behavior of a first object which is manipulated by the first input unit and a second object which is manipulated by the second input unit,
the game control unit prepares the gaming space, controls the respective behaviors of the first and the second objects in the gaming space based on the instructions inputted from the first and the second input units and, at the same time, determines a relative distance in the gaming space between the first and the second objects by grasping the respective positions of the first and the second objects in the gaming space, and
the display control unit, in response to the relative distance between the first and the second objects in the gaming space which is determined by the game control unit, changes over the screen between a common screen which indicates the behavior of the first and the second objects in the gaming space and individual screens which indicate an image as viewed from the first object in the gaming space as the first image and an image as viewed from the second object in the gaming space as the second image.
